(19) United States
(12) Patent Application Publication
(10) Pub. No.: US 2005/0275759 A1
(43) Pub. Date: Dec. 15, 2005

(54) Rear-projection type imaging apparatus

(76) Inventor: Takashi Itohiya, Saitama-shi (JP)

Correspondence Address: JACOBSON HOLMAN PLLC, 400 SEVENTH STREET N.W., SUITE 600, WASHINGTON, DC, 20004, US

(21) Appl. No.: 10/935,147

(22) Filed: Sep. 8, 2004

(30) Foreign Application Priority Data
Jun. 11, 2004 (JP) 2004-174397

(51) Int. Cl. H04N 5/64

(52) U.S. Cl. 348/744

(57) ABSTRACT

A rear-projection type imaging apparatus, for example, rear-projection television set, capable of projecting, and displaying, an enlarged image onto a screen from the rearward thereof is provided. The rear-projection television set (100) comprises a housing (114), a television control unit (signal processing unit) (128), an image display element (120), a projection lens system (130), an image projecting mirror (140), a screen (150) onto which an enlarged image is projected from the backward thereof. The projection lens system (130) is comprised of a rear-group optical system (132), an intermediate mirror (132) and a front-group optical system (136). Lens barrels (146, 142) associated with the front-group and rear group optical systems (136,132), respectively, are fastened to each other by fastening means.

### BACKGROUND OF THE INVENTION

1. Field of the Invention

The present invention relates to a rear-projection type imaging apparatus which can project, and display, an enlarged image onto a screen from the rearward thereof, such as rear-projection television sets or rear projectors. In particular, the present invention relates to a rear-projection type imaging apparatus configured to reduce vibration in a projection lens system due to sounds coming out of woofers.

2. Background Art

Conventional rear projectors comprise a lower cabinet containing an image forming section and a main screen body, and are configured to project an enlarged image (or enlarged picture) onto the main screen body from the backward thereof (e.g., see Japanese Patent Laid-Open Application No. 2003-274314 (particularly, Pages 4-6, FIGS. 1-7 thereof)). Conventional back projection type imaging apparatuses are also of such a structure that comprises an upper cabinet and a lower cabinet and that is configured to project, and display, an enlarged image (or enlarged picture) onto a screen from the backward thereof. The lower cabinet is provided with a light source and a speaker arranged in the lower cabinet (e.g., see Japanese Patent Laid-Open Application No. HEISEI-9(1997)-98359 (particularly, Pages 2-4, FIGS. 1-3 thereof)). Furthermore, conventional rear-projection television sets comprise an upper cabinet including a screen and mirror disposed therewithin and a lower cabinet which contains various main components, i.e., an imaging apparatus, a drive/control circuit, an optical unit including projection lenses and a source of light (e.g., see Japanese Patent Laid-Open Application No. HEISEI-9(1997)-98357 (particularly, Pages 3-4, FIGS. 1-6 thereof)).

FIGS. 13 and 14 show an example of conventional rear projectors. Referring to FIGS. 13 and 14, there is shown a rear projector 900 which comprises an upper cabinet 910 and a lower cabinet 912. An operation control section 928 is provided to receive external signals relating to image and audio information and to output image and audio signals for controlling the operation of the rear projector. The operation control section 928 is disposed within the central portion of the lower cabinet 912 at the rearward part thereof. An image display element 920 for displaying an image (or picture) is disposed within the central portion of the lower cabinet 912 at the rearward part thereof, the image display element 920 being located forward of the television control section 928. A projection lens system 930 is disposed within the central portion of the lower cabinet 912 at the forward part thereof and located forward of the image display element 920 for enlarging and projecting the image displayed by the image display element 920. An image projecting mirror 940 is disposed in the rearward slope of the upper cabinet 910 for reflecting the image projected by the projection lens system 930. The reflection face of the image projecting mirror 940 is oriented at an angle of 55 degrees relative to the horizontal plane. A screen 950 onto which the enlarged image reflected from the image projecting mirror 940 is projected from the backward of the screen, is disposed on the front face of the central portion of the upper cabinet 910. The display area of the screen 950 is positioned at an angle of 90 degrees relative to the horizontal plane. A first tweeter 960 is located on the right side of the upper cabinet 910. A second tweeter 962 is located on the left side of the upper cabinet 910. A first woofer 964 is located on the rightward portion of the lower cabinet 912. A second woofer 966 is located on the leftward portion of the lower cabinet 912.

The image display element 920 is connected to the operation control section 928 and can receive the image signal from the operation control section 928 to display the image information thereon. The tweeters 960, 962 and the woofers 964, 966 are also connected to the operation control section 928 and can receive the audio signals from the operation control section 928 to generate sounds. The projection lens system 930 comprises a rear-group optical system 932 including a plurality of convex lenses for converging rays from the image displayed by the image display element 920, an intermediate mirror 934 for reflecting the rays passing through the rear-group optical system 930 and a front-group optical system 936 including a plurality of concave lenses for diffusing the rays reflected by the intermediate mirror 934. The rear-group optical system 932 is disposed forward of the image display element 920. The rear-group optical system 932 is supported within a lens barrel 942. The intermediate mirror 934 is disposed forward of the rear-group optical system 932. The front-group optical system 936 is disposed upward and rearward of the intermediate mirror 934. The front-group optical system 936 is supported within a lens barrel 946. The rear-group optical system 932 defines an optical axis 932x which is oriented at an angle of 20 degrees relative to the horizontal plane. The reflecting face of the intermediate mirror 934 is positioned at an angle of 90 degrees relative to the horizontal plane. The front-group optical system 936 defines an optical axis 936x which is oriented at an angle of 70 degrees relative to the horizontal plane. The image displayed on the image display element 920 is reflected by the intermediate mirror 934 after passed through the rear-group optical system 932, enlarged by the front-group optical system 936 after passed therethrough and then reflected by an image projecting mirror 940 toward the screen 950 so that the image will be projected onto the screen 950 from the backward thereof. Such a structure can cause a user to view the image displayed by the image display element 920 in an enlarged scale from the front side of the screen 950.

In recent years, the rear-projection television sets have been required to be increasingly reduced in thickness or of more low profile by advent of low profile or thinner plasma television sets. However, reduction of the rear-projection television set in thickness requires shortening of the distance of projection in a projection lens system. To shorten the distance of projection in the projection lens system, then, it is further required to shorten its focal distance and to widen its angle. As the angle of the projection lens system is widened, however, the diameter of a forwardmost lens in the projection lens system is correspondingly increased, thus leading to the increased weight of the forwardmost lens in the projection lens system. Also, for inexpensive and mass production, projection lens barrels have been often made of plastic material which can form the barrels more easily than metals. When the projection lens barrel is formed of plastic material, the rigidity of the projection lens barrel will be reduced in comparison with the weight of the forwardmost lens in the projection lens system. This presents a problem in that the projection lens system will be vibrated due to the heavy bass produced by the woofers. The same is true of the rear projector.

Referring to FIG. 14, the image projected onto the screen 950 in the rear projector 900 is one that is provided by scaling up an original image in the image display element 920 such as a liquid crystal panel by as much as several tens of times. If the forwardmost lens 938 of the projection lens system 930 is caused to vibrate during the projection, an angle θ1 formed between the optical axis 936x of the front-group optical system 936 and the optical axis 932x of the rear-group optical system 932 will be changed to create a width of deflection “a” at the tip of the forwardmost lens 938 in the projection lens system 930. Even if such a width of deflection a is only slight, the deflection is enlarged to create a width of deflection “a′” at the screen 950. Thus, the vibration of the forwardmost lens 938 during the projection may lead to an appreciable vertical sway in the image being projected onto the screen 950. Also, any torsion force exerted onto the forwardmost lens 938 can cause an appreciable horizontal sway in the image projected onto the screen 950. The sway often becomes more conspicuous, particularly, if an image including straight lines as in a building or if subtitles are projected.

It is therefore an object of the present invention is to provide a rear-projection type imaging apparatus such as a rear projection television set or rear projector, which can prevent a sway of image which would result from vibration in a projection lens system produced by the heavy bass from the woofers or the like.

Another object of the present invention is to provide a rear-projection type imaging apparatus which less require to ensure accuracy in component parts associated with the projection lens system and which can be disassembled and reassembled in an easy and simple manner.

### SUMMARY OF THE INVENTION

The present invention relates to a rear-projection type imaging apparatus capable of projecting, and displaying, an enlarged image onto a screen from the rearward thereof, comprising a housing for containing components, a signal processing unit for receiving signals relating to image and audio information and controlling operation of the rear-projection type imaging apparatus, an image display element coupled to the signal processing unit for receiving the image signals generated by the signal processing unit and displaying the image thereon, woofer means coupled to the signal processing unit for receiving the audio signals generated by the signal processing unit and outputting bass sounds, and a projection lens system for enlarging and projecting the image displayed on the image display element, the woofer means and the projection lens system being disposed in the housing, the projection lens system being comprised of a rear-group optical system including at least one convex lens adapted to converge rays from the image displayed on the image display element and a front-group optical system including at least one concave lens adapted to diffusing the rays which has passed through the rear-group optical system. According to an aspect of the rear-projection type imaging system of the invention, the rear-group optical system is supported within a corresponding lens barrel, the front-group optical system is also supported within a corresponding lens barrel, and the respective lens barrels for the front-group and rear group optical systems are fastened to each other by fastening means. Such an arrangement can prevent any image sway which would otherwise occur due to vibration in the projection lens system created by the heavy bass from the woofer means.

According to another aspect of the rear-projection type imaging apparatus of the invention, it is preferred that the lens barrels for the front-group and rear-group optical systems are fastened to each other by means of the fastening means which includes a locating pin and a fixing screw. With such an arrangement, it is possible to effectively prevent any change in the angle between the respective optical axes of the front-group and rear-group optical systems due to the vibration in the forwardmost lens of the projection lens system during projection as well as any run-out of the optical axis of the front-group optical system if the torsion force is exerted on the forwardmost lens.

According to another aspect of the rear-projection type imaging apparatus of the invention, the lens barrels for the front-group and rear-group optical systems can be fastened to each other by use of an adhesive. With such an arrangement, the respective lens barrels for the front-group and rear-group optical systems can be securely attached to each other regardless of accuracy of the component parts since the adhesive may flow into any gap which would exist between the lens barrels.

According to another aspect of the rear-projection type imaging apparatus of the invention, the lens barrels for the front-group and rear-group optical systems can be fastened to each other by means of fastening means including a boss and an adhesive between the lens barrels. With such an arrangement, the respective lens barrels for the front-group and rear-group optical systems can be securely attached to each other regardless of accuracy of the component parts since the adhesive may flow into any gap which would exist between the lens barrels. In addition, the provision of the boss can provide a more robust structure since the boss may effectively resist relative movement of the lens barrels when a greater force is applied to the forwardmost lens of the projection lens system.

According to another aspect of the rear-projection type imaging apparatus of the invention, a cushion member can be disposed between the respective lens barrels for the front-group and rear-group optical systems. With such an arrangement, the respective lens barrels for the front-group and rear-group optical systems can be closely engaged to each other regardless of accuracy of the component parts by means of the cushion member disposed between the lens barrels so as to fill any gap which would exist therebetween.

According to another aspect of the rear-projection type imaging apparatus of the invention, the lens barrels for the front-group and rear-group optical systems can be fastened to each other by means of fastening means including a boss, in addition to the cushion member disposed therebetween. With such an arrangement, the respective lens barrels for the front-group and rear-group optical systems can be closely engaged to each other regardless of accuracy of the component parts by means of the cushion member disposed between the lens barrels so as to fill any gap which would exist therebetween. In addition, the provision of the boss can provide a more robust structure since the boss may effectively resist relative movement of the lens barrels when a greater force is applied to the forwardmost lens of the projection lens system.

According to another aspect of the rear-projection type imaging apparatus of the invention, the lens barrels for the front-group and rear-group optical systems can be fastened to each other by means of fastening means including a locating pin and a fixing screw, in addition to the cushion member disposed therebetween. With such an arrangement, the respective lens barrels for the front-group and rear-group optical systems can be closely engaged to each other regardless of accuracy of the component parts by means of the cushion member disposed between the lens barrels so as to fill any gap which would exist therebetween. Also, with such an arrangement, it is possible to effectively prevent any change in the angle between the respective optical axes of the front-group and rear-group optical systems due to the vibration in the forwardmost lens of the projection lens system during projection as well as any run-out of the optical axis of the front-group optical system if the torsion force is exerted on the forwardmost lens.

According to a further aspect of the rear-projection type imaging apparatus of the invention, the signal processing unit can be configured to receive television signals from TV stations, output signals relating to image and audio information, and control the operation of the rear-projection television set. With such an arrangement, the rear-projection television set can be constructed in such a manner as to prevent any image sway which would result from vibration in a projection lens system produced by the heavy bass from the woofers or the like.

The present invention provides a rear-projection type imaging apparatus which is constructed to effectively prevent any vibration in a front-group optical system of a projection lens system, thereby avoiding any image sway in an efficient and effective manner. Accordingly, a user can view the rear-projection type imaging apparatus comfortably with his/her eyes not becoming tired. Also, the rear-projection type imaging apparatus of the present invention less requires to ensure accuracy in parts associated with the projection leans system and can be disassembled and reassembled in an easy and simple manner. Therefore, the rear-projection type imaging apparatus of the present invention requires less number of steps to manufacture as well as less time to perform maintenance or the like.

### BRIEF DESCRIPTION OF THE DRAWINGS

FIG. 1 is a side elevation view, partly in section, showing a structure of each of a projection lens system, a reflecting mirror and a screen of a rear-projection television set according to a first embodiment of the invention;

FIG. 2 is a sectional view showing the structure of the rear-projection television set of the first embodiment of the invention;

FIG. 3 is a perspective view showing the general construction of the rear-projection television set of the first embodiment of the invention;

FIG. 4 is a top view showing a structure of the projection lens system of the rear-projection television set of the first embodiment of the invention;

FIG. 5 is a side elevation view showing a structure of the projection lens system of the rear-projection television set of the first embodiment of the invention;

FIG. 6 is a fragmentary side elevation view, partly in section, showing a structure of a first type of a fastening structure for use with the projection lens system of the rear-projection television set according to the first embodiment of the invention;

FIG. 7 is a fragmentary side elevation view showing a structure of a second type of the fastening structure for use with the projection lens system of the rear-projection television set according to the first embodiment of the invention;

FIG. 8 is a fragmentary side elevation view, partly in section, showing a structure of a third type of the fastening structure for use with the projection lens system of the rear-projection television set according to the first embodiment of the invention;

FIG. 9 is a fragmentary side elevation view, partly in section, showing a structure of a fourth type of the fastening structure for use with the projection lens system of the rear-projection television set according to the first embodiment of the invention;

FIG. 10 is a fragmentary side elevation view, partly in section, showing a structure of a fifth type of the fastening structure for use with the projection lens system of the rear-projection television set according to the first embodiment of the invention;

FIG. 11 is a fragmentary side elevation view, partly in section, showing a structure of a sixth type of the fastening structure for use with the projection lens system of the rear-projection television set according to the first embodiment of the invention;

FIG. 12 is a side elevation view, partly in section, showing a general construction of a rear projector according to a second embodiment of the invention and includes a perspective view of various components of the rear projector;

FIG. 13 is a perspective view showing the general construction of a rear-projection television set of the prior art; and

FIG. 14 is a sectional view showing a structure of each of a projection lens system, a reflecting mirror and a screen of the rear-projection television set shown in FIG. 13.

### DETAILED DESCRIPTION OF THE PREFERRED EMBODIMENTS

Several preferred embodiments of the present invention will now be described with reference to the accompanying drawings. A rear-projection type imaging apparatus according to the present invention is based on or includes a concept that provides an imaging apparatus configured to project an enlarged image onto a screen from the backward thereof, such as a rear projection television set or a rear projector.

### (1) First Embodiment

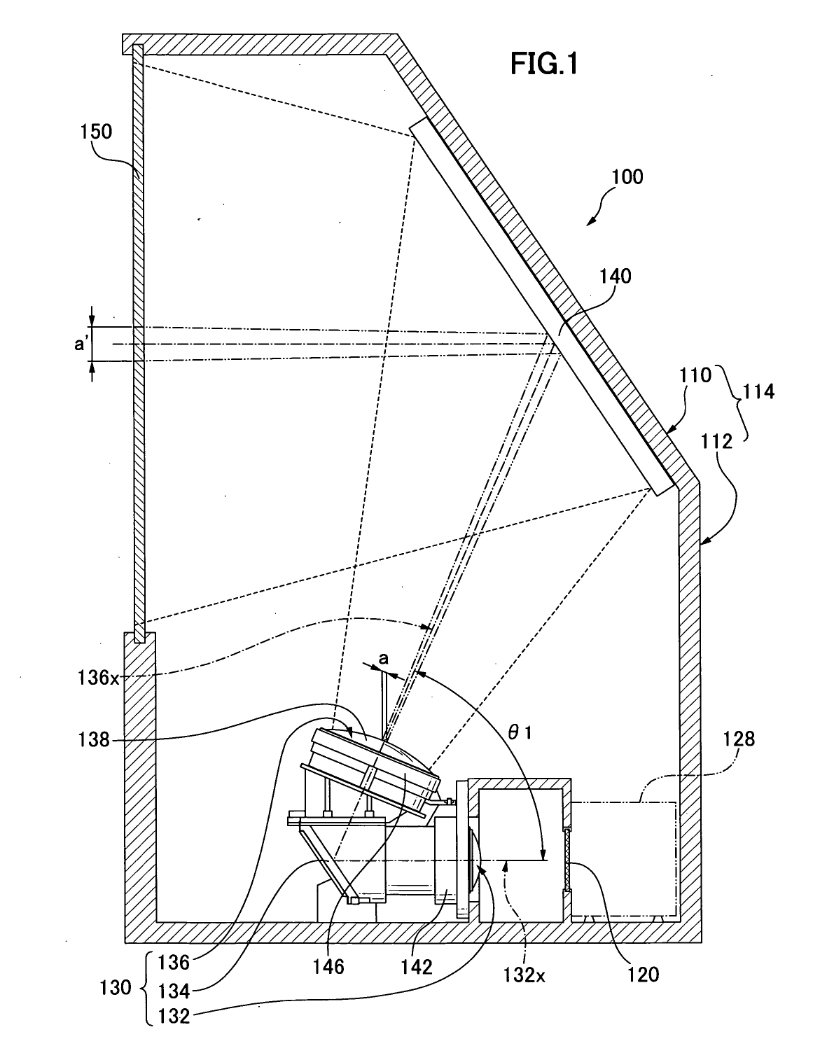

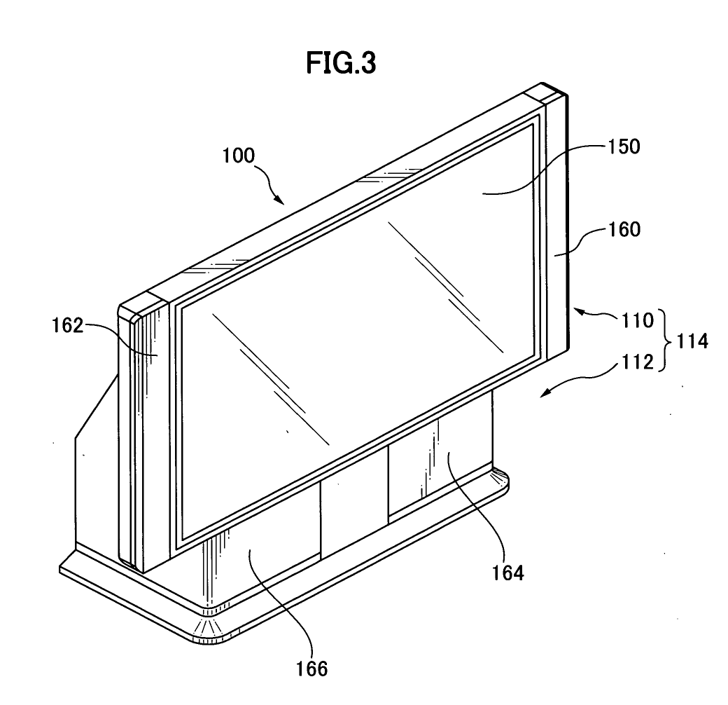

A first embodiment of the present invention relates to a rear-projection television set among rear-projection type imaging apparatuses. Referring to FIGS. 1 and 3, the rear-projection television set 100, which is a rear-projection type imaging apparatus according to one embodiment of the present invention, is configured such that an enlarged image from the television set can be projected and displayed onto a screen from the backward thereof. The rear-projection television set 100 comprises a housing 114 for receiving various components. The housing 114 preferably includes an upper cabinet 110 and a lower cabinet 112. Alternatively, the housing 114 may be of an integral structure without dividing into upper and lower cabinets.

A television control unit 128 is disposed in the central portion of the lower cabinet 112 at the rearward part thereof for receiving television signals from TV stations, outputting signals relating to image and audio information and controlling the operation of the rear-projection television set. A receiver antenna (not shown) may be connected to the television control unit 128. An image display element 120 is disposed in the central portion of the lower cabinet 112 at the rearward part thereof and also forward of the television control unit 128 for receiving the image signals from the television control unit 128 and displaying a television image (or picture) thereon. The television control unit 128 may be disposed in any position at the rearward part of the lower cabinet 112. The television control unit 128 also forms a signal processing unit in the rear-projection television set 100.

The image display element 120 may be in the form of a liquid crystal panel. A projection lens system 130 is disposed in the central portion of the lower cabinet 112 forward of the image display element 120 for enlarging and projecting the image displayed by the image display element 120. An image projecting mirror 140 is disposed on the rearward part of the upper cabinet 110 for reflecting the image projected by the projection lens system 130 and projecting it onto a screen from the backward thereof. Preferably, the image projecting mirror 140 is fixedly mounted and supported on the rearward part of the upper cabinet 110. The reflecting face of the image projecting mirror 140 is oriented at an angle of 60 degrees relative to the horizontal plane. The reflecting face of the image projecting mirror 140 may be positioned at any angle other than 60 degrees relative to the horizontal plane. Alternatively, the imaging apparatus may comprise a plurality of image projecting mirrors. Furthermore, the imaging apparatus may be configured so that a projection lens system can project an image onto a screen from the backward thereof without the use of the image projecting mirror.

A screen 150 onto which the enlarged image reflected at the image projecting mirror 140 is projected from the backward of the screen is disposed in the central portion of the upper cabinet 110 at the front side thereof. Preferably, the screen 150 is fixedly mounted and supported on the front side of the upper cabinet 110. The display area of the screen 150 is positioned at an angle of 90 degrees relative to the horizontal plane. The display area of the screen 150 may be positioned at any angle other than 90 degrees relative to the horizontal plane. A first tweeter (right-side tweeter) 160 is disposed on the right side of the upper cabinet 110. The first tweeter 160 is connected to the television control unit 128 and adapted to receive audio signals from the television control unit 128 for outputting treble sounds. A second tweeter (left-side tweeter) 162 is disposed on the left side of the upper cabinet 110. The second tweeter 162 is connected to the television control unit 128 and adapted to receive audio signals from the television control unit 128 for outputting treble sounds. A first woofer (right-side woofer) 164 is disposed on the right side of the lower cabinet 112. The first woofer 164 is connected to the television control unit 128 and adapted to receive audio signals from the television control unit 128 for outputting bass sounds. A second woofer (left-side woofer) 166 is disposed on the left side of the lower cabinet 112. The second woofer 166 is connected to the television control unit 128 and adapted to receive audio signals from the television control unit 128 for outputting bass sounds. The woofers 164, 166 and projection lens system 130 are received in the lower portion of the housing 114 (or within the lower cabinet 112) adjacent to one another.

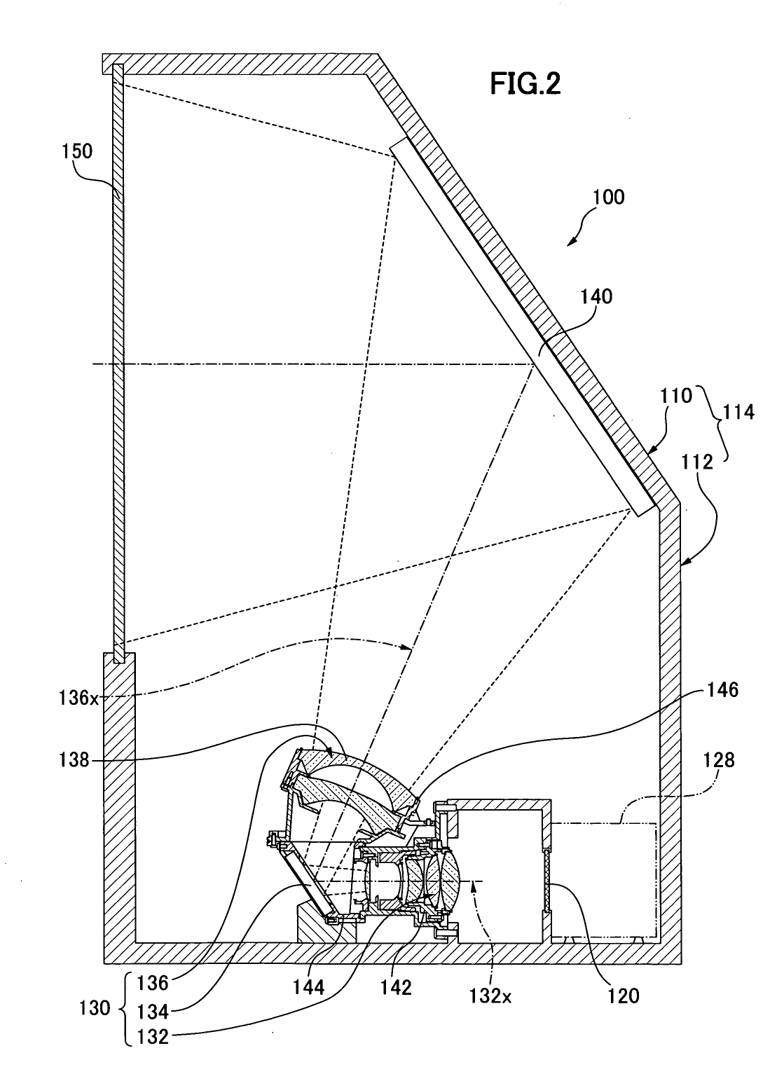

The image display element 120 is connected to the television control unit 128 and can receive image signals from the television control unit 128 for displaying image information. Referring to FIG. 2, it is particularly preferable that the image display element 120 is fixedly mounted and supported on the lower cabinet 112. It is also preferable that the television control unit 128 is fixedly mounted and supported on the lower cabinet 112. The tweeters 160, 162 and the woofers 164, 166 are adapted to be connected to the television control unit 128 and to receive audio signals from the television control unit 128 for outputting audio sounds.

The projection lens system 130 comprises a rear-group optical system 132 including a plurality of convex lenses for converging rays from the image displayed by the image display element 120, an intermediate mirror 134 for reflecting the rays passing through the rear-group optical system 130, and a front-group optical system 136 including a plurality of concave lenses for diffusing the rays reflected at the intermediate mirror 134. The rear-group optical system 132 may comprise a single convex lens or a combination of one or more convex lenses with one or more concave lenses. The front-group optical system 136 may comprise a single concave lens or a combination of one or more concave lenses with one or more convex lenses. Alternatively, each of these optical systems may be combined with an additional convex lens and/or a convex lens. Furthermore, the image projection system 130 may be configured so that the optical axes of the front-group and rear-group optical systems 136, 132 will be aligned with each other without the provision of the intermediate mirror 134. The rear-group optical system 132 and/or the front-group optical system 136 may be configured to include one or more lenses which are movable to perform the focusing of the optical systems in the direction of optical axis.

The rear-group optical system 132 is disposed forward of the image display element 120. The rear-group optical system 132 is supported within a lens barrel 142 which can be formed by aluminum die-casting or of an engineering plastic (e.g., polycarbonate, PPS, etc.). Referring to FIG. 2, it is particularly preferred that the barrel 142 for the rear-group optical system is firmly supported on the lower cabinet 112 using any fastening means such as screw fastening. The intermediate mirror 134 is disposed forward of the rear-group optical system 132. The intermediate mirror 134 includes an intermediate mirror retaining member 144 which is supported on the barrel 132 for the rear-group optical system using any fastening means such as fitting/fixing means. The front-group optical system 136 is disposed upward of the intermediate mirror 134. The front-group optical system 136 is supported within a barrel 146 for the front-group optical system. The barrel 146 can be made of aluminum die-casting or of an engineering plastic (e.g., polycarbonate, PPS, etc.). The front-group optical system barrel 146 is supported on the intermediate mirror retaining member of the intermediate mirror 134 using any fastening means such as screw fastening. The optical axis 132x of the rear-group optical system 132 is oriented parallel to the horizontal plane. The optical axis 132x of the rear-group optical system 132 may be oriented at an angle relative to the horizontal plane.

The reflecting face of the intermediate mirror 134 is positioned at an angle of 60 degrees relative to the horizontal plane. The reflecting face of the intermediate mirror 134 may also be oriented at an angle other than 60 degrees relative to the horizontal plane. The optical axis 136x of the front-group optical system 136 is oriented at an angle of 60 degrees relative to the horizontal plane. The optical axis 136x of the front-group optical system 136 may also be oriented at an angle other than 60 degrees relative to the horizontal plane. The image displayed at the image display element 120 is reflected by the intermediate mirror 134 after passed through the rear-group optical system 132, enlarged by the front-group optical system 136 and then reflected by the image projecting mirror 140 toward a screen 150 so that the image will be projected onto the screen 150 from the backward thereof. By utilizing such a structure, a user can view the image displayed by the image display element 120 in an enlarged scale from the front side of the screen 150. The user can operate the rear-projection television set 100 using a remote controller (now shown). The upper cabinet 110 and/or the lower cabinet 112 may include a control unit including a display section and switches.

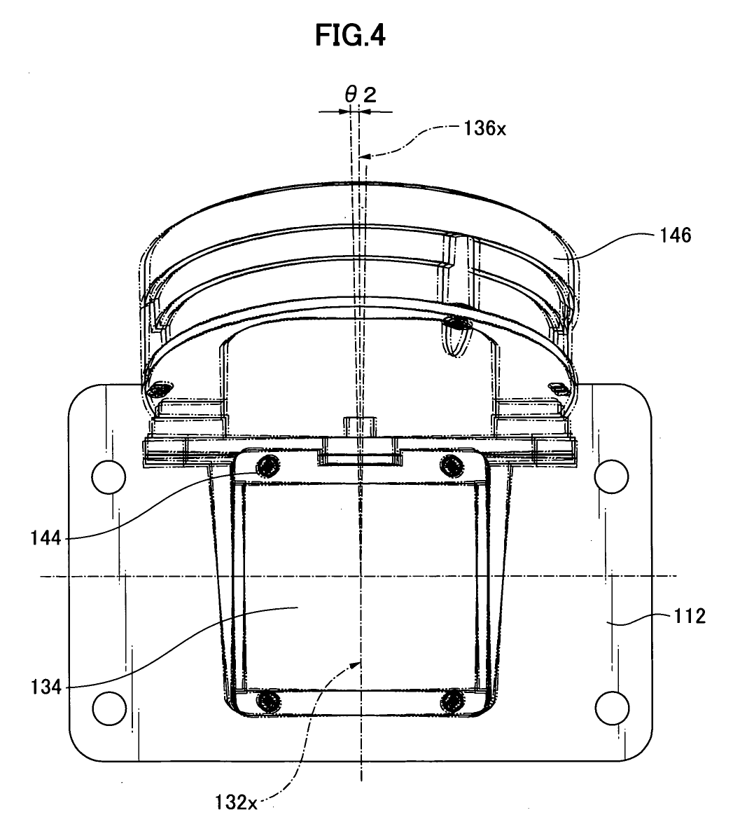

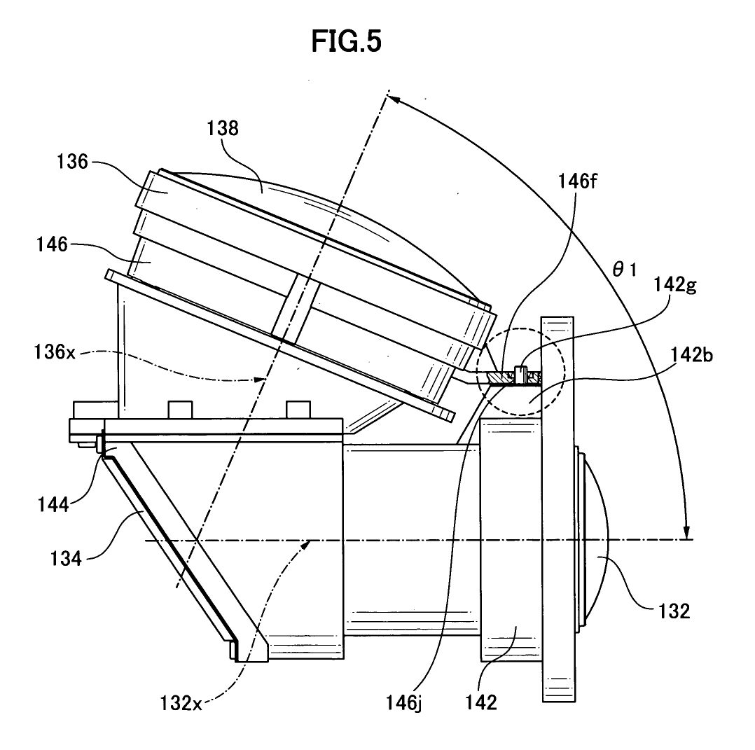

Referring to FIGS. 1 and 5, the image projected onto the screen 150 of the rear-projection television set 100 is one that is provided by enlarging an original image on the image display element 120 such as liquid crystal panel to several tens of times. When the forwardmost lens 138 of the projection lens system 130 is vibrated during projection, an angle θ1 included between the optical axis of the front-group optical system 136 and the optical axis of the rear-group optical system 132 is changed to create a width of deflection “a” at the tip of the forwardmost lens 138 in the projection lens system 130. Even if such a width of deflection “a” is only slight, the deflection will be enlarged to create a width of deflection “a′” at the screen 150. In other words, when the forwardmost lens in the projection lens system 130 is vibrated during projection, a great sway in the vertical direction may be created in the image projected onto the screen 150. When a torsion force acts on the forwardmost lens 138 to change the optical axis 136x of the front-group optical system 136 only by an angle θ2 as shown in FIG. 4, a great sway in the horizontal direction may be created in the image projected onto the screen 150.

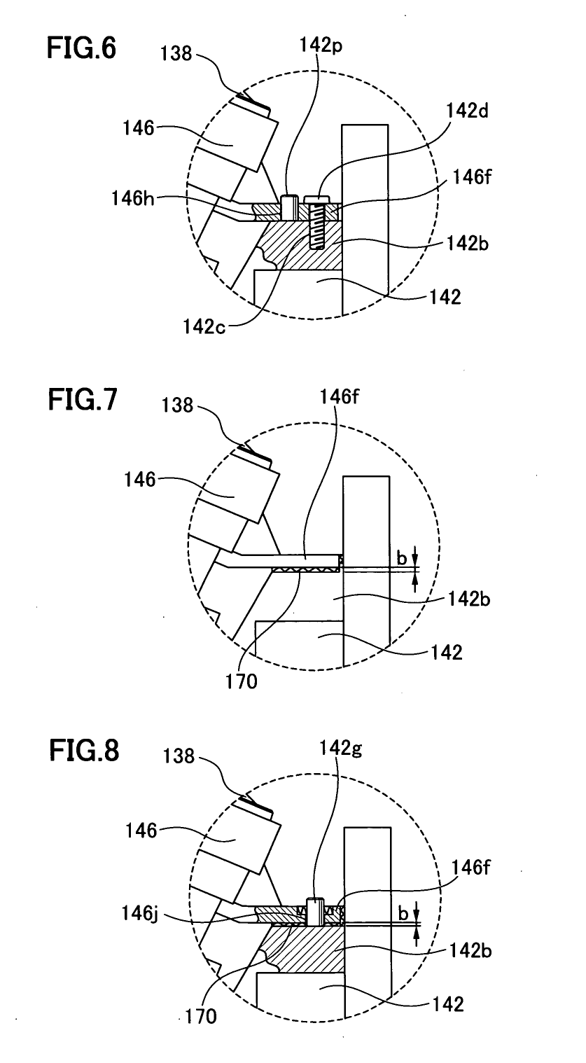

In the rear-projection television set 100 of the present invention, the front-group optical system barrel 146 and rear-group optical system barrel 142 are fastened to each other to reduce the occurrence of said width of deflection “a” and/or the horizontal sway. In other words, the fastening part of the front-group optical system barrel 146 is fastened to the fastening part of the rear-group optical system 142 through a fastening structure. With such an arrangement, these angles θ1 and θ2 can be prevented from being changed, this resulting in reduction of the sway in the image. Referring to FIG. 6, there is shown a first type of fastening structure which includes a mount 146f provided on the outer periphery of the front-group optical system barrel 146 at the rearward part thereof. The mount 146f may be in the form of a flange. The mount 146f of the front-group optical system barrel 146 has a guide hole 146h formed therethrough. A retaining member 142b is provided on the upper part of the rear-group optical system barrel 142. The retaining member 142b may be in the form of a pedestal. A locating pin 142p is provided on the top face of the retaining member 142b. A threaded hole 142c is prodided in the top face of the retaining member 142b.

With the locating pin 142p inserted into the guide hole 146h, a fixing screw 142d is screwed into the threaded hole 142c such that the mount 146f can be fixedly attached to the retaining member 142b. An internal thread may have been formed in the threaded hole 142c. Alternatively, if the fixing screw 142d is in the form of a self-taping screw, the threaded hole 142c may be replaced by a simple hole without an internal thread. With such an arrangement, it is possible to effectively prevent any change in the angle θ1 between the optical axis of the front-group optical system 136 and the optical axis and the rear-group optical system 132 due to the vibration in the forwardmost lens 138 of the projection lens system 130 during projection. Furthermore, with such an arrangement, it is possible to effectively prevent a run-out of the optical axis 136x of the front-group optical system 136 by the angle θ2 when the torsion force is exerted on the forwardmost lens 138.

Alternatively, referring to FIG. 7, there is shown a second type of fastening structure which includes a mount 146f provided on the outer periphery of the front-group optical system barrel 146 at the rearward part thereof. A retaining member 142b is provided on the upper part of the lens barrel 142. The mount 146f can be securely attached relative to the retaining member 142b by means of an adhesive 172. With this arrangement, the secure attachment of the mount 146f to the retaining member 142b can be performed regardless of accuracy of the component parts since the adhesive 172 can flow into a gap “b” which would exist between the lower surface of the mount 146f and the upper surface of the retaining member 142b. Accordingly, with such arrangement, it is not necessary that designed dimensions of the component parts should be held to very close tolerances in order to eliminate any gap “b”. Also, with such an arrangement, it is possible to effectively prevent any change in the angle θ1 between the optical axis of the front-group optical system 136 and the optical axis and the rear-group optical system 132 due to the vibration in the forwardmost lens 138 of the projection lens system 130 during projection as well as a run-out of the optical axis 136x of the front-group optical system 136 by the angle θ2 when the torsion force is exerted on the forwardmost lens 138.

Alternatively, referring to FIGS. 5 and 8, there is shown a third type of fastening structure which includes a mount 146f provided on the outer periphery of the front-group optical system barrel 146 at the rearward part thereof. The mount 146f of the front-group optical system barrel 146 has a guide hole 146h formed therethrough. A boss 142g is provided on the upper surface of the retaining member 142b. With the boss 142g extending through the guide hole 146j, the mount 146f can be securely attached relative to the retaining member 142b by means of an adhesive 172. Such secure attachment of the mount 146f to the retaining member 142b can be performed regardless of accuracy of the component parts since the adhesive 172 can flow into a gap “b” which would exist between the lower surface of the mount 146f and the upper surface of the retaining member 142b. The provision of the boss 142g on the upper surface of the retaining member 142b provides a more robust structure since the boss may effectively resist relative movement of the mount 146f when a greater force is exerted on the forwardmost lens of the projection lens system 130.

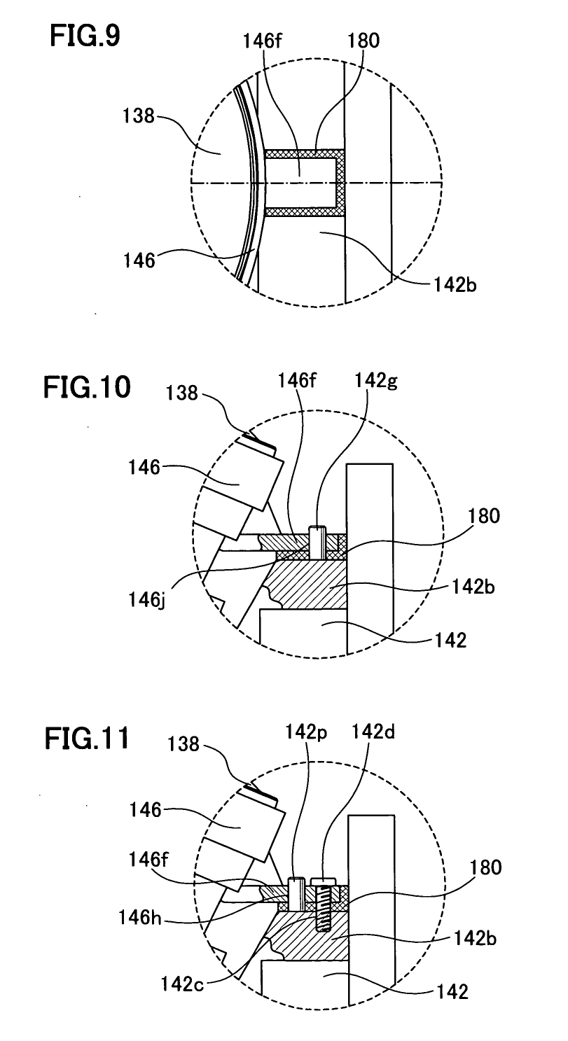

Alternatively, referring to FIG. 9, there is shown a fourth type of fastening structure which includes a mount 146f provided on the outer periphery of the front-group optical system barrel 146 at the rearward part thereof. A retaining member 142b is provided on the upper part of the lens barrel 142. A cushion member 180 can be disposed between the lower surface of the mount 146f and the upper surface of the retaining member 142b for establishing a closely engaging relationship between the mount 146f and the retaining member 142b. Such close engagement can be attained regardless of accuracy of the component parts by means of the cushion member 180 which is inserted into and fill a gap “b” which would exist the lower surface of the mount 146f and the upper surface of the retaining member 142b. The cushion member can comprise NBR, rubber or the like. With this arrangement, the cushion member 180 can accommodate any change in the angle θ1 between the optical axis of the front-group optical system 136 and the optical axis and the rear-group optical system 132 due to the vibration in the forwardmost lens 138 of the projection lens system 130 during projection. Furthermore, with this arrangement, easy disassembly of the component parts can be performed because of use of the cushion member 180, but no use of any adhesive.

Alternatively, referring to FIG. 10, there is shown a fifth type of fastening structure which includes a mount 146f provided on the outer periphery of the front-group optical system barrel 146 at the rearward part thereof. The mount 146f of the front-group optical system barrel 146 has a guide hole 146h formed therethrough. A retaining member 142b is provided on the upper part of the lens barrel 142 associated with the rear-group optical system. A boss 142g is provided on the upper surface of the retaining member 142b. A cushion member 180 can be placed between the lower surface of the mount 146f and the upper surface of the retaining member 142b and may establish a closely engaging relationship between the mount 146f and the retaining member 142b with the boss extending through the guide hole 146j. Such close engagement can be attained regardless of accuracy of the component parts by means of the cushion member 180 which is inserted into and fill a gap “b” which would exist the lower surface of the mount 146f and the upper surface of the retaining member 142b. The cushion member can comprise NBR, rubber or the like. Furthermore, the provision of the boss 142g on the upper surface of the retaining member 142b provides a more robust structure since the boss may effectively resist relative movement of the mount 146f when a greater force is exerted on the forwardmost lens of the projection lens system 130. Also, with such an arrangement, it is possible to effectively prevent any change in the angle θ1 between the optical axis of the front-group optical system 136 and the optical axis and the rear-group optical system 132 due to the vibration in the forwardmost lens 138 of the projection lens system 130 during projection as well as a run-out of the optical axis 136x of the front-group optical system 136 by the angle θ2 when the torsion force is exerted on the forwardmost lens 138. Furthermore, with this arrangement, easy disassembly of the component parts can be performed because of use of the cushion member 180, but no use of any adhesive which would otherwise must be removed.

Alternatively, referring to FIG. 11, there is shown a sixth type of fastening structure which includes a mount 146f provided on the outer periphery of the front-group optical system barrel 146 at the rearward part thereof. The mount 146f of the front-group optical system barrel 146 has a guide hole 146h formed therethrough. A retaining member 142b is provided on the upper part of the lens barrel 142 associated with the rear-group optical system. A locating pin 142p is provided on the top face of the retaining member 142b. A threaded hole 142c is formed in the top face of the retaining member 142b. A cushion member 180 can be disposed between the lower surface of the mount 146f and the upper surface of the retaining member 142b. With the cushion member 180 disposed between the lower surface of the mount 146f and the upper surface of the retaining member 142b and also with the locating pin 142p engaged by the guide hole 146h, the fixing screw 142d is screwed into the threaded hole 142c such that the mount 146f can be fixedly attached to the retaining member 142b. An internal thread may have been formed in the threaded hole 142c. Alternatively, if the fixing screw 142d is in the form of a self-taping screw, the threaded hole 142c may be replaced by a simple hole without an internal thread. Even if there is a gap “b” between the lower surface of the mount 146f and the upper surface of the retaining member 142b, the cushion member 180 can disposed in the gap “b” so that the mount 146f may closely engage the retaining member 142b regardless of accuracy of the component parts. The cushion member can comprise NBR, rubber or the like. Furthermore, the provision of the boss 142g on the upper surface of the retaining member 142b provides a more robust structure since the boss may effectively resist relative movement of the mount 146f when a greater force is exerted on the forwardmost lens of the projection lens system 130. Also, with such an arrangement, it is possible to effectively prevent any change in the angle θ1 between the optical axis of the front-group optical system 136 and the optical axis and the rear-group optical system 132 due to the vibration in the forwardmost lens 138 of the projection lens system 130 during projection as well as a run-out of the optical axis 136x of the front-group optical system 136 by the angle θ2 when the torsion force is exerted on the forwardmost lens 138. Furthermore, with this arrangement, easy disassembly of the component parts can be performed because of use of the cushion member 180, but no use of any adhesive.

While the above description relates to the first to sixth types of fastening structures wherein the mount 146f and the retaining member 142b are provided on the lens barrels 146 and 142 associated with the front-group and rear-group optical systems 136 and 132, respectively, the mount 146f and the retaining member 142b can be provided on the lens barrels 142 and 146 associated with the rear-group and front-group optical systems 132 and 136, respectively. Accordingly, the locating pin 142p can be provided either on the retaining member on the lens barrel 146 or on the retaining member on the lens barrel 142. The threaded hole 142c can also be provided either in the retaining member on the lens barrel 146 or in the retaining member on the lens barrel 142. The guide hole 146h can be can also be provided either in the mount on the lens barrel 146 or in the mount on the lens barrel 142. The boss can be provided either on the retaining member of the lens barrel 146 or on the retaining member of the lens barrel 142.

Also, while the above description relates to the first to sixth types of fastening structures wherein the single mount 146f and retaining member 142b are provided on the lens barrels 146 and 142 associated with the front-group and rear-group optical systems 136 and 132, respectively, a plurality of the mounts 146f and the retaining members 142b can be provided on the lens barrels 142 and 146 associated with the rear-group and front-group optical systems 132 and 136, respectively.

As described above, the present invention provides a rear-projection type imaging apparatus which is constructed to effectively prevent any vibration in a front-group optical system of a projection lens system due to the heavy bass from the woofers or the like, thereby avoiding any image sway in an efficient and effective manner. Also, the rear-projection television set of the present invention less requires to ensure accuracy in parts associated with the projection leans system and can be disassembled and reassembled in an easy and simple manner.

### (2) Second Embodiment

A second embodiment of the rear-projection type imaging apparatus of the present invention will now be described. The following description relates largely to differences between the first and second embodiments of the rear-projection type imaging apparatus of the present invention. Therefore, as to matters which are not described hereinafter with respect to the second embodiment, reference should be made to the foregoing description of the first embodiment of the rear-projection type imaging apparatus of the present invention. The second embodiment of the present invention relates to a rear projector among the rear-projection type imaging apparatus.

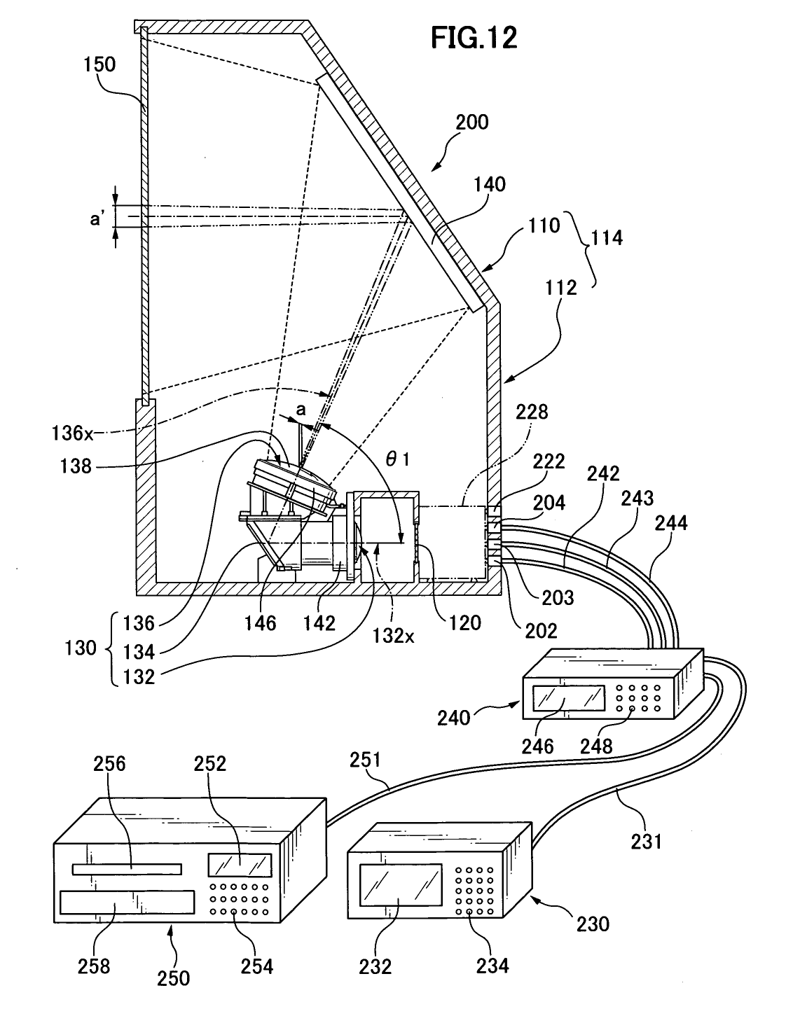

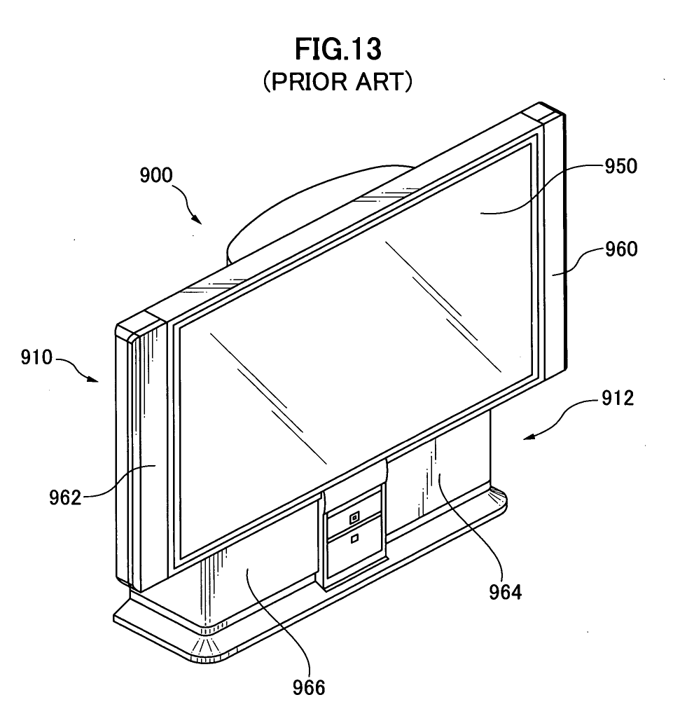

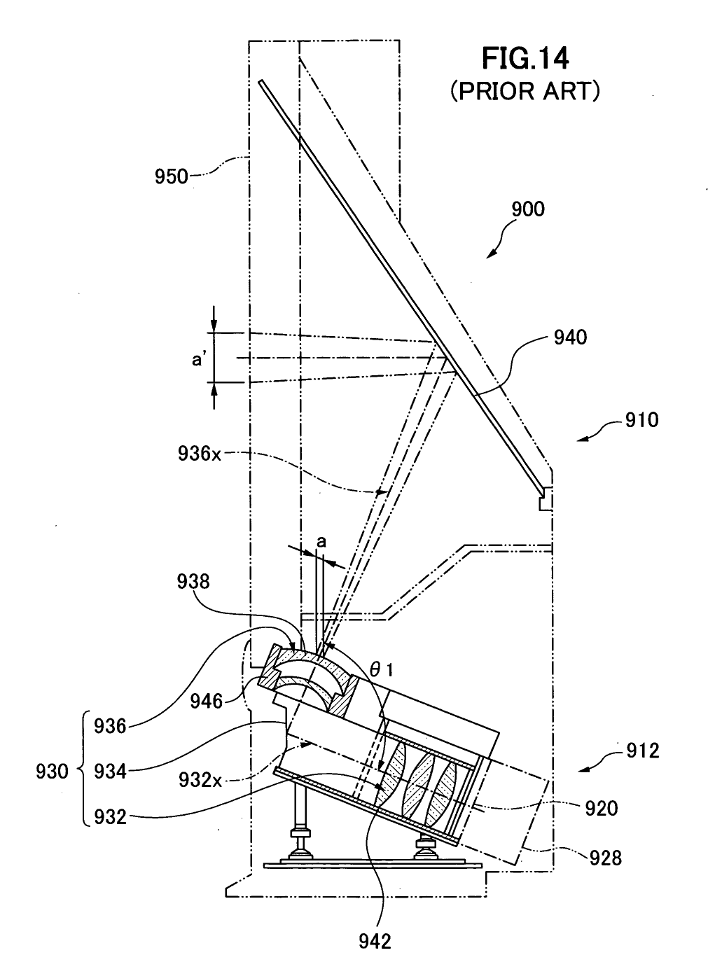

Referring to FIG. 12, the rear projector 200, which is depicted as an example of the rear-projection type imaging apparatus, is constructed such that an enlarged image can be projected and displayed onto a screen from the backward thereof. The rear projector 200 comprises a housing 114 for containing various components. The housing 114 includes an upper cabinet 110 and a lower cabinet 112. A signal processing unit 228 is disposed in the central portion of the lower cabinet 112 at the rearward part thereof for receiving signals relating to image and audio information from the outside, outputting image and audio signals and controlling the operation of the rear projector 200. An image display element 120 is disposed in the central portion of the lower cabinet 112 at the rearward part thereof and also forward of the signal processing unit 228 for receiving the image signals outputted from the signal processing unit 228 and displaying the image (or picture). The signal processing unit 228 may be disposed in any position at the rearward part of the lower cabinet 112. First input terminal 202 is disposed on the lower cabinet 112 for receiving a left audio signal from an external device. Second input terminal 203 is disposed on the lower cabinet 112 for receiving a right audio signal from the external device. Third input terminal 204 is disposed on the lower cabinet 112 for receiving an image signal from the external device. Also, an auxiliary input terminal 222 is disposed on the lower cabinet 112 for receiving signals such as image and/or audio signals from various image and/or audio output equipments. The auxiliary terminal 222 also is connected to the signal processing unit 228. The user can operate the rear projector 200 using a remote controller (not shown).

A tuner 230 is provided for receiving television signals from TV stations and outputting signals relating to image and audio information and has its output terminal connected to one of input terminals (not shown) on an amplifier 240 via a connecting cable 231. A receiver antenna (not shown) can be connected to the tuner 230. the connecting cable 231 can be configured to transmit the right and left audio signals, and the image signal. When it is desired that the right and left audio signals and the image signal are separately transmitted, a total of three separate connecting cables can be utilized for transmitting these signals separately. The tuner 230 is provided with display 232 for indicating states of operation of the tuner and a control panel 234 for controlling the tuner 230. The display 232 can comprise a liquid crystal panel, LED or the like. The control panel 234 can comprise a pushbutton, a rotary dial, a slide switch, a touch-sensitive switch or the like. The tuner 230 can be controlled to receive the television signals and provide signals relating to image and audio information to the signal processing unit 228 of the rear projector 200. A remote controller (not shown) can be used to control the tuner 230.

A video player 250 is provided for receiving signals relating to image and audio information stored in recording media, such as video tapes, DVD discs, DVD-R's, CD-ROM's or the like and outputting signals relating to image and audio information provided and has its output terminal connected to another input terminal on an amplifier 240 via a connecting cable 251. The connecting cable 251 can be configured to transmit the right and left audio signals, and the image signal. When it is desired that the right and left audio signals and the image signal are separately transmitted, a total of three separate connecting cables can be utilized for transmitting these signals separately. The video player 250 is provided with display 252 for indicating states of operation of the video player, a control panel 254 for controlling the video player 250, a DVD disc compartment 256 for receiving a DVD disc, DVD-R's, CR-ROM's etc., and a video tape compartment 258 for receiving a video tape etc. The display 252 can comprise a liquid crystal panel, LED or the like. The control panel 254 can comprise a pushbutton, a rotary dial, a slide switch, a touch-sensitive switch or the like. The video player 250 can be controlled to read the image and audio signals off the recording media, such as video tapes, DVD discs, DVD-R, CD-ROM or the like and provide them to the signal processing unit 228 of the rear projector 200. A remote controller (not shown) can be used to control the video player 250.

The amplifier 250 is provided with display 246 for indicating states of operation of the amplifier 230 and a control panel 248 for controlling the amplifier 230. The display 246 can comprise a liquid crystal panel, LED or the like. The control panel 248 can comprise a pushbutton, a rotary dial, a slide switch, a touch-sensitive switch or the like. First output terminal (for example, for transmitting the right audio signal) (not shown) of the amplifier 240 is connected to the first input signal 202 of the rear projector 200 via a connecting cable 242. Second output terminal (for example, for transmitting the left audio signal) (not shown) of the amplifier 240 is connected to the second input signal 203 of the rear projector 200 via a connecting cable 243. Third output terminal (for example, for transmitting the image signal) (not shown) of the amplifier 240 is connected to the third input signal 204 of the rear projector 200 via a connecting cable 242. A remote controller (not shown) can be used to control the video player 250.

Also, any one of various image and/or audio output equipments, such as a video camera is coupled to the auxiliary terminal (AUX terminal) 222 via a connecting cable (not shown). In this way, the image and/or audio signals from the external image and/or audio output equipments can be transmitted to the signal processing unit 228.

The present invention provides a rear-projection type imaging apparatus, such as a rear-projection television set, a rear projector or the like which is constructed to reduce vibration in a projection lens system due to sounds coming out of woofers. The present invention also provides a rear-projection type imaging apparatus which can be disassembled and reassembled in an easy and efficient manner.

### LIST OF REFERENCE NUMERALS

100 rear-projection television set
110 upper cabinet
112 lower cabinet
114 housing
120 image display element
128 television control unit
130 projection lens system
132 rear-group optical system
134 intermediate mirror
136 front-group optical system
140 image projecting mirror
142 lens barrel for rear-group optical system
142b retaining member
142c threaded hole
142d fixing screw
142p locating pin
146 lens barrel for front-group optical system
146f mount
146h guide hole
150 screen
160.162 tweeter
164,166 woofer
200 rear projector
202 television input terminal
204 video input terminal
206 auxiliary terminal
228 signal processing unit
230 tuner
250 video player

1. A rear-projection type imaging apparatus capable of projecting, and displaying, an enlarged image onto a screen from the rearward thereof, comprising:
a housing for containing components;
a signal processing unit for receiving signals relating to image and audio information and controlling operation of the rear-projection type imaging apparatus;
an image display element coupled to the signal processing unit for receiving the image signals generated by the signal processing unit and displaying the image thereon;
woofer means coupled to the signal processing unit for receiving the audio signals generated by the signal processing unit and outputting bass sounds; and
a projection lens system for enlarging and projecting the image displayed on the image display element;
said woofer means and the projection lens system being disposed in the housing;
said projection lens system being comprised of a rear-group optical system including at least one convex lens adapted to converge rays from the image displayed on the image display element and a front-group optical system including at least one concave lens adapted to diffuse the rays which has passed through the rear-group optical system;
said rear-group optical system being supported within a corresponding lens barrel;
said front-group optical system being supported within a corresponding lens barrel; and
said respective lens barrels for the front-group and rear group optical systems being fastened to each other by fastening means.

2. An rear-projection type imaging apparatus as defined in claim 1, wherein said lens barrels for the front-group and rear-group optical systems are fastened to each other by means of the fastening means which includes a locating pin and a fixing screw.

3. An rear-projection type imaging apparatus as defined in claim 1, wherein said lens barrels for the front-group and rear-group optical systems can be fastened to each other by use of an adhesive.

4. An rear-projection type imaging apparatus as defined in claim 1, wherein said lens barrels for the front-group and rear-group optical systems are fastened to each other by means of fastening means including a boss and an adhesive.

5. An rear-projection type imaging apparatus as defined in claim 1, further comprising a cushion member disposed between said lens barrels for the front-group and rear-group optical systems.

6. An rear-projection type imaging apparatus as defined in claim 1, further comprising a cushion member disposed between said lens barrels for the front-group and rear-group optical systems, said lens barrels for the front-group and rear-group optical systems being fastened to each other by means of fastening means including a boss.

7. An rear-projection type imaging apparatus as defined in claim 1, further comprising a cushion member disposed between said lens barrels for the front-group and rear-group optical systems, said lens barrels for the front-group and rear-group optical systems being fastened to each other by means of fastening means including a locating pin and a fixing screw.

8. An rear-projection type imaging apparatus as defined in claim 1, wherein said signal processing unit are configured to receive television signals from TV stations, output signals relating to image and audio information, and control the operation of the rear-projection television set.
